(19) United States
(12) Patent Application Publication
(10) Pub. No.: US 2021/0353977 A1
(43) Pub. Date: Nov. 18, 2021

(54) INTEGRATED RESPIRATORY AND EYE PROTECTIVE SYSTEM

(71) Applicant: D. Wheatley Enterprises, Inc., Belcamp, MD (US)

(72) Inventors: Patrick Hulbert, Dallastown, PA (US); David Hanson, Street, MD (US); Robert Elliott, Bel Air, MD (US)

(21) Appl. No.: 17/319,519

(22) Filed: May 13, 2021

Related U.S. Application Data
(60) Provisional application No. 63/024,267, filed on May 13, 2020.

(51) Int. Cl. A62B 18/02; A62B 18/08

(52) U.S. Cl. CPC A62B 18/025; A62B 18/084; A62B 18/082

(57) ABSTRACT

Disclosed is an integrated respiratory and eye protective system that is light-weight and easily carried, is fast and easy to apply by a user, and that ensures protection of a user against inhalation or ingestion of or exposure to environmental contaminants, including for example dangerous aerosolized chemical, biological, and radiological materials. The system includes a mask that fits tightly over a user's nose and mouth and down and around their neck, with two filter assemblies on either side of the mask that filter environmental contaminants out of the air as the user breathes in through the mask. Goggles are provided that provide a single, continuous seal against the user's face and about the user's eyes, with the bottom, central portion of the goggles configured to engage and closely mate with the top, central portion of the mask.

### CROSS-REFERENCE TO RELATED APPLICATIONS

This application is based upon and claims the benefit of U.S. Provisional Application No. 63/024,267 titled “Integrated Respiratory and Eye Protective System,” filed May 13, 2020, which application is incorporated herein by reference in its entirety.

### FIELD OF THE INVENTION

This invention relates generally to personal protective equipment, and more particularly to easy-to-use and apply protective equipment for protecting a user against inhalation, ingestion, and general exposure to environmental contaminants, and that can be flat-folded for easy and compact storage and carrying until needed.

### BACKGROUND

Personal protective equipment plays a critical role in protecting users, such as medical personnel, emergency first responders, and military forces, from potential harmful exposure to a wide variety of contaminants, which in varying environments may comprise airborne chemical or biological agents that could cause significant medical harm if inhaled, ingested, or otherwise contacted by the user. For instance, health care workers are at serious risk of themselves contracting contagions from their patients without effective personal protective equipment that shields their face from inadvertent exposure. Likewise, emergency first responders and military forces may be called upon to act in environments contaminated with highly hazardous agents that may expose them to risk of injury or death if inhaled, ingested or contacted while operating in those environments—such as chemical spills, terrorist attacks involving chemical, biological, or radiological elements, and the like. While a wide variety of powered systems or self-contained breathing systems are available to such operators, those systems are not always suitable for all environments due to their limited operating duration, their size and weight, the time that they can take to apply and/or change out, their difficulty to carry for long periods, and a number of other factors that would make it far more preferable to operate with a light, easily-applied and removed piece of protective equipment, assuming such equipment can in fact provide protection against the specific environmental threat that is faced by the user.

Thus, there remains a need in the art for personal protective equipment that ensures protection against exposure to environmental contaminants, but that is sufficiently simple in construction such that it may be easily carried and stored, quickly deployed, and comfortably worn for long periods by the user.

### SUMMARY OF THE INVENTION

Disclosed herein is an integrated respiratory and eye protective system that is light-weight and easily carried and stored, that is fast and easy to apply by a user, and that ensures protection of a user against inhalation or ingestion of or other contact with environmental contaminants, including for example dangerous aerosolized chemical, biological, and radiological materials. The system includes a mask that fits tightly over a user's nose and mouth and down and around their neck, with two filter assemblies on either side of the face of the mask that filter environmental contaminants out of the air as the user breathes in through the mask. The filter assemblies preferably provide approximately 100 cm′ of filter medium. The mask is largely constructed of an flexible elastic material, preferably a performance polymer which may comprise by way of non-limiting example 2.0 mil neoprene, that allows the user to wear the mask for an extended duration without pain or discomfort that could otherwise require the user to remove the mask or modify it in a way that could impair its sealing and filtering performance. Goggles may also be provided that provide a single, continuous seal against the user's face and around the user's eyes, with the bottom, central portion of the goggles configured to engage and closely mate with the top, central portion of the mask. In certain exemplary configurations, the goggles may be part of a single assembly in which the goggles frame is permanently affixed to the mask. As the mask is largely comprised of a flexible material, it may be folded to a generally flat configuration and stored on a wearer's body, such as in a pocket or compartment of a user's clothing, backpack, or similar carriers, and quickly pulled out and placed over the top of the user's head to cover their nose, mouth, and eyes when required for use.

In accordance with certain aspects of an embodiment of the invention, a protective system is provided comprising a flat-folding elastic polymer material covering having a lower portion sized to fit around a wearer's neck, an upwardly extending portion having a nose bridge portion positioned to overlap a bridge of the nose of the wearer, and a front spine portion extending downward from the nose bridge portion and terminating at a chin portion positioned to overlap a chin of the wearer, a first flat filter assembly mounted on the elastic polymer material covering on a first side of the front spine and positioned to overlap a first cheek of the wearer, a second flat filter assembly mounted on the elastic polymer material covering on a second side of the front spine opposite the first side and positioned to overlap a second cheek of the wearer, and an interior sealing frame mounted to an interior of the elastic polymer material covering, the interior sealing frame forming a continuous wearer's face-engaging surface and defining a rear edge of an enclosed breathing cavity between the wearer's face and interior surfaces of the elastic polymer material covering and of the first and second flat filter assemblies.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE FIGURES

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a side view of an integrated respiratory and eye protective system in accordance with certain aspects of an embodiment of the invention.

FIG. 2 is a front perspective view of the integrated respiratory and eye protective system of FIG. 1.

FIG. 3 is a perspective view of an interior sealing frame for use in the integrated respiratory and eye protective system of FIGS. 1 and 2.

FIGS. 4(a) and 4(b) are front and perspective views, respectively, showing placement of the interior sealing frame of FIG. 3 against a user's face.

FIG. 5 is a perspective view of a goggle portion of the integrated respiratory and eye protective system of FIGS. 1 and 2.

FIG. 6 is a cross-sectional view of a filter assembly for use in the mask of the integrated respiratory and eye protective system of FIGS. 1 and 2.

FIG. 7 is a perspective view of an integrated respiratory and eye protection system in accordance with further aspects of an embodiment of the invention.

FIG. 8 is a front view of the integrated respiratory and eye protective system of FIG. 7.

FIG. 9 is a perspective view of the integrated respiratory and eye protective system of FIG. 7 applied to a wearer's face.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

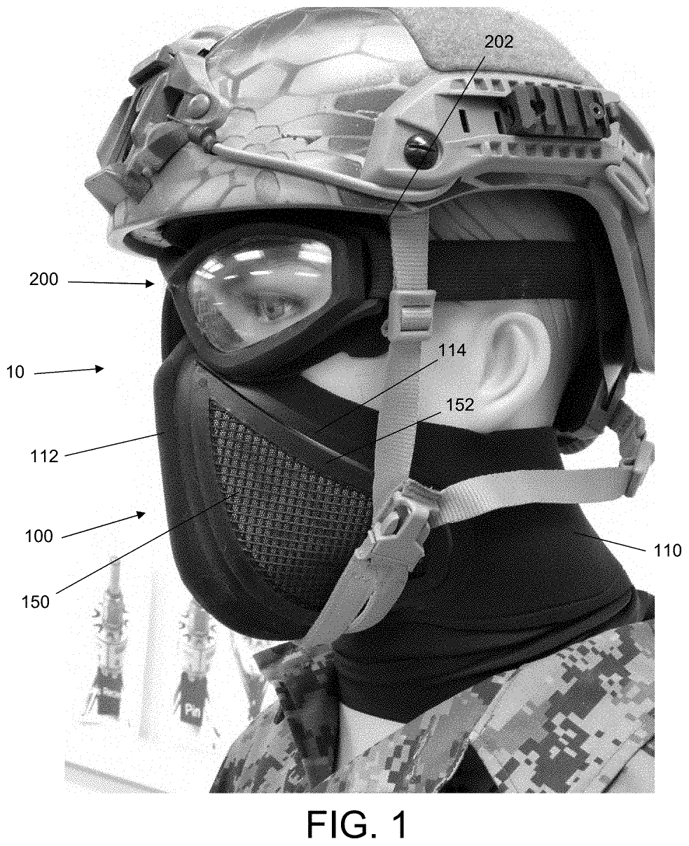

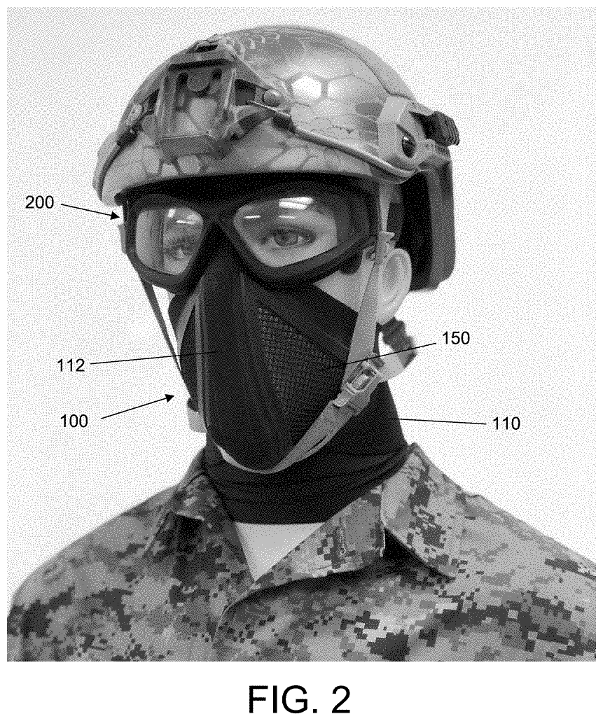

In accordance with certain aspects of an embodiment and with reference to FIGS. 1 and 2, a person-worn protective system, and more particularly an integrated respiratory and eye protection system (shown generally at 10) is provided including a flexible, flat-folding mask 100 and goggles 200. Mask 100 includes a stretchable, elastic polymer material covering 110 that wraps around a user's neck and the bottom portion of their face, including their nose and mouth, and that carries generally flat filter assemblies 150 that are configured, as described in greater detail below, to protect a wearer of the mask from inhaling or ingesting harmful environmental contaminants, such as chemical, radiological, and/or biological agents. Importantly, the flat profile and flexible nature of mask 100 allow the mask 100 to be carried or otherwise transported flat, and mask 100 may easily and quickly be donned by the user when they find themselves in a hazardous environment. The interior of mask 100 includes a sealing member that is configured to contact the user's skin around at least a portion of the perimeter of the flat filter assemblies 150, including at the top portion of the mask that extends over the bridge portion of the user's nose and their upper cheeks below their eyes, and under their jaw up to their chin, to define an interior, closed breathing chamber inside of the mask 100. Further, goggles 200 form a continuous seal against the wearer's face around the entire perimeter of the goggles, which seal is configured to sit flush against the nose bridge portion of mask 100, and extends above the user's eyebrow to provide a maximum field of view while ensuring a sealingly protective fit against the user's face.

As best shown in FIGS. 1 and 2, the face-covering portion of mask 100 includes center spine 112. In certain exemplary configurations, center spine 112 may be formed of an at least semi-rigid plastic, such as by way of non-limiting example urethane, which center spine 112 extends centrally down the face-covering portion of mask 100 from the bridge of the user's nose to beneath their chin. In other exemplary configurations, center spine 112 may be formed of the same flexible, stretchable elastic polymer material of the rest of mask 100 that wraps around the bridge of the user's nose, down along their cheeks and ultimately to and wrapping around their neck. Likewise in certain exemplary configurations, filter carriers 114 are provided and may be affixed to or formed as a single piece with stretchable elastic polymer material covering 110. In certain exemplary configurations, filter carriers 114 may be formed of an at least semi-rigid plastic, such as by way of non-limiting example urethane, and are positioned on opposite sides of center spine 112. In such exemplary configurations, filter carriers 114 may form at least semi-rigid frames configured to receive and mount flat filter assemblies 150. In certain configurations, flat filter assemblies 150 are rigidly affixed to filter carriers 114 during manufacture of mask 100 to maximize the tightness of the seal between them, in which case mask 100 may be used for a single or small number of potential exposures and then disposed of and replaced with a new mask 100. In other configurations, flat filter assemblies 150 may be removably attached to filter carriers 114 of mask 100 in a configuration that ensures a tight and sealing fit between flat filter assemblies 150 and filter carriers 114. In such exemplary configurations, each flat filter assembly 150 includes a filter frame 152 (which itself may be formed by way of non-limiting example of an at least semi-rigid plastic such as urethane) that connects to filter carriers 114, and a filter medium 160 (the preferred configuration of which is discussed in greater detail below) positioned in an interior of filter frame 152. In other configurations, filter frame 152 may be joined directly to stretchable elastic polymer material covering 110, with filter carriers 114 being defined by an inner edge of a window in stretchable elastic polymer material covering 110 sized to receive flat filter assemblies 150, such as by thermal welding, adhesively joining them together, or such other attachment methods as will readily occur to those of ordinary skill in the art.

Thus, at least center spine 112 and filter frames 152 form a structure that maintains the shape of the portion of mask 100 that covers the user's nose and mouth, positioning and maintaining each flat filter assembly 150 on opposite sides of center spine 112 and slightly away from the user's face. In such configuration and during use, a user inhales air through each flat filter assembly 150, and their exhaled air similarly passes through flat filter assemblies 150 in the opposite direction of airflow.

As noted above, center spine 112 and filter carriers 114 are affixed to or formed integrally with stretchable elastic polymer material covering 110, which when worn extends over the bridge of the user's nose, downward across the user's face and extending further downward and rearward to cover the user's neck. In certain configurations, stretchable elastic polymer material covering 110 may comprise a tight-fitting rubber, preferably a performance polymer which may comprise by way of non-limiting example 2.0 mil neoprene, which may provide a tight seal against the skin of the user's face, head and neck while maintaining a comfortable fit for the user.

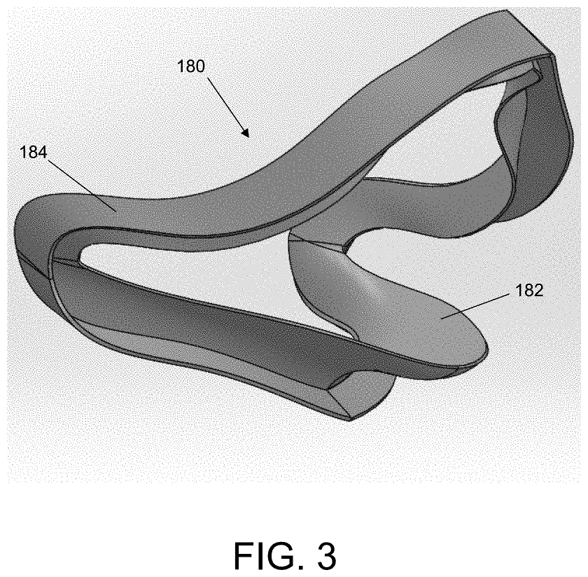

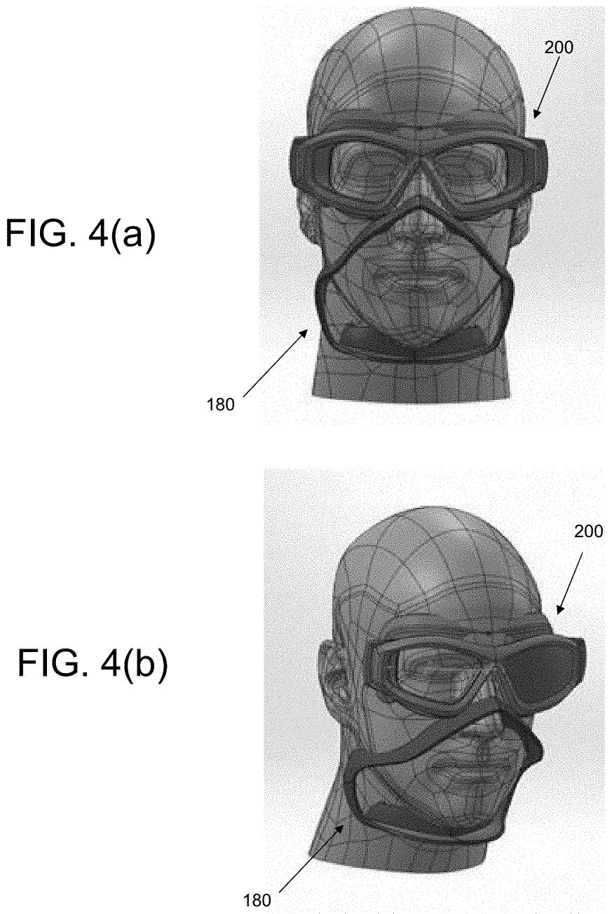

To further aid in both sealingly fitting mask 100 against the user's face and maintaining the intended shape profile of mask 100 at the user's face, and with reference to FIGS. 3, 4(a) and 4(b), an interior sealing frame 180 is provided which is affixed on an interior side of mask 100. In accordance with certain aspects of an embodiment, FIGS. 4(a) and 4(b) show placement of an exemplary interior sealing frame 180 against a user's face, with the mask portion removed for clarity of the interior sealing frame 180. Interior sealing frame 180 includes a face engaging strip 182 that sits flush against the bottom portion of the user's chin, extends rearward along their lower jawline, and from approximately the position of the user's rear jaw extends upwards curving towards the bridge of the user's nose, thus forming a continuous sealing strip against the user's face, isolating the interior breathable portion of mask 100 from any external contaminants. Face engaging strip 182 is affixed to the interior perimeter of mask mounting strip 184. Likewise, the outer perimeter of mask mounting strip 184 mounts directly to the interior of mask 100. Specifically and in certain exemplary configurations, the interior of stretchable elastic polymer material covering 110 may be affixed to the outer face of mask mounting strip 184, and as such stretchable elastic polymer material covering 110 will stretch when placed around the user's face and neck, the stretchable elastic polymer material covering 110 will elastically pull interior sealing frame 180 (and particularly the continuous sealing strip formed by interior sealing frame 180) against the user's face to help isolate the interior breathable portion of mask 100 from any external contaminants. In a particular configuration, interior sealing frame 180 may be formed of a flexible material, such as rubber, that may form a sealing engagement with the skin on the user's face. By way of non-limiting example, in certain configurations interior sealing frame 180 may be composed of 60A polyurethane or TPE.

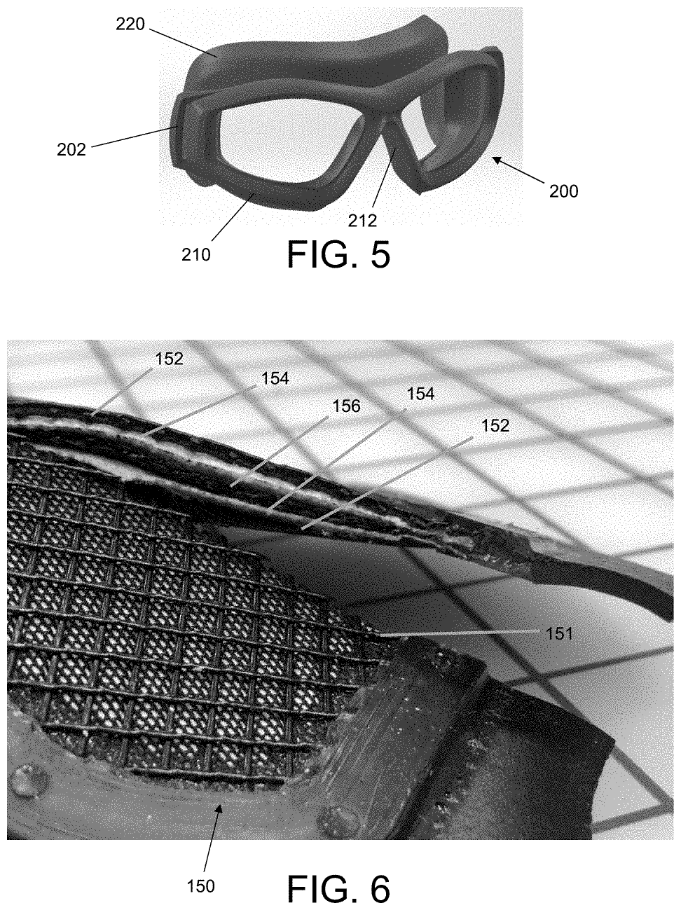

In accordance with further aspects of an embodiment, and with continuing reference to FIGS. 4(a) and 4(b) and as particularly shown in FIG. 5, goggles 200 are also preferably provided, which goggles 200 are particularly configured to both provide a continuous seal around both of the user's eyes, and to mate closely with the upper portion of mask 100 so as to maintain a maximum field of view for the user. Goggles 200 include an eye-framing front rim 210 having a nose bridge portion 212. Nose bridge portion 212 includes angled sidewalls that closely match the contours of the upper, outer edges of center spine 112 of mask 100, such that when both are worn together by a user, goggles 200 (and particularly nose bridge portion 212) rest on the top of center spine 112 of mask 100 with a sufficiently close fit to further aid in sealing both the mask 100 and goggles 200 against the user's face. Further, goggles 200 include a rear, face-engaging continuous rim 220 that extends around the full, rear perimeter of goggles 200 to form a continuous seal of goggles 200 against the user's face around their eyes. The top portion of continuous rim 220 extends above eye-framing front rim 210, and is thus configured to extend overtop of the user's eyebrows when worn. Goggles 200 also preferably include strap receivers 202 that receive an adjustable strap to allow a user to customize the fit of goggles 200 for maximum sealing engagement against their face.

Next, FIG. 6 provides a close-up, cross-sectional view of one of filter assemblies 150. Each filter assembly 150 is preferably configured to provide protection against environmental contaminants, such as harmful chemical, biological and radiological agents that, if inhaled or ingested, could cause injury or death. In a particularly preferred configuration, each filter assembly 150 comprises an outer layer of rigid mesh 151, which in certain configurations may comprise nylon. Next, a layer of flexible nylon mesh 152 may be provided of finer mesh size than outer layer of rigid mesh 151. Layer 152 of flexible nylon mesh may comprise, by way of non-limiting example, SPANDEX. Next, preferably multiple layers, and more preferably three layers, of particulate filtration media 154 are provided. In certain configurations, each layer of particulate filtration media may comprise an advanced filtering media, such as by way of non-limiting example advanced electret media. Next, a layer of activated carbon fiber cloth 156 may be provided, such as by way of non-limiting example FLEXZORB FM100 activated carbon cloth available from Calgon Carbon Corporation. Next, another layer 154 of particulate filtration media configured as described above may be provided. Finally, another layer 152 of nylon mesh may be provided at an interior side of filter assemblies 150. Preferably, each filter assembly 150 provides a surface area of approximately 50 cm² through which a user may draw air, thus providing an overall filtration surface area of approximately 100 cm², which has been found to provide an optimum balance of breathability and contaminant filtration for the user while maintaining a compact, easily stored, flat-folding protective system. Moreover, each filter assembly 150 configured as above preferably provides sufficient antiviral protection to ensure against infiltration of harmful particles from patients suffering from Ebola, SARS, COVID-19, and the like.

Such mask 100 incorporated with filter assemblies 150 as described above provides a flat-folding, comfortable, and easily worn and removed mask with sufficient filtration capability to protect the user from breathing in dangerous chemical, biological, or radiological elements that could cause injury or even death without such protective equipment.

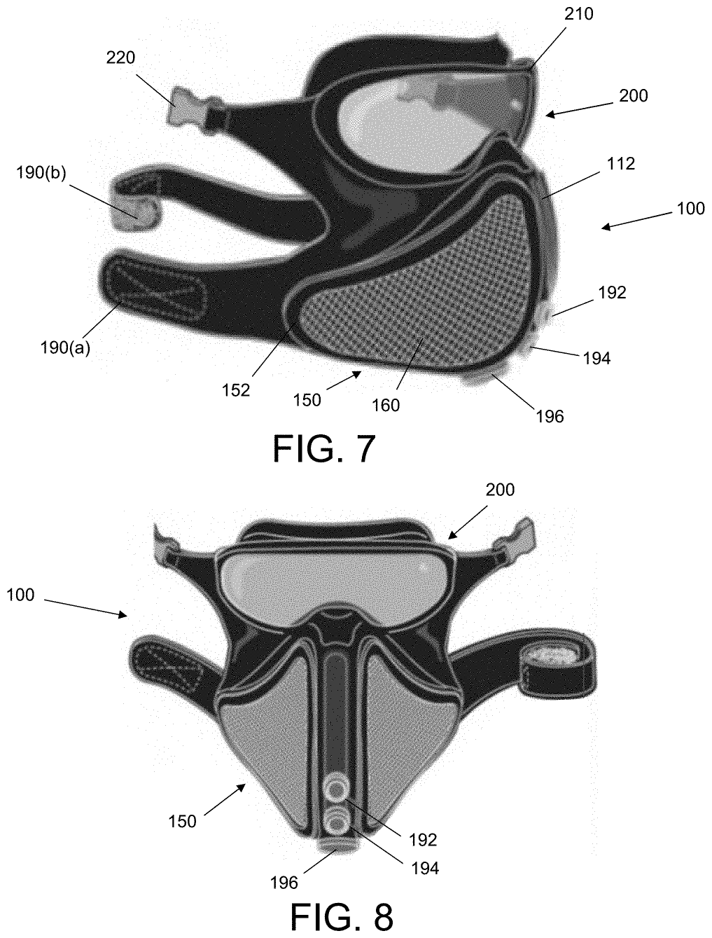

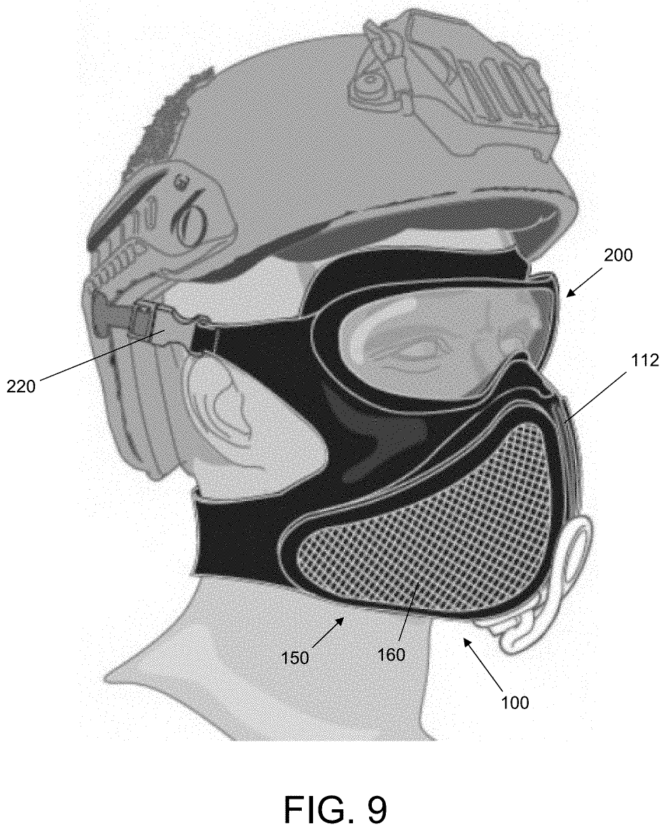

In accordance with certain further features of an embodiment of the invention, and with particular reference to FIGS. 7-9, goggles 200 may in certain configurations be integrated into elastic polymer material covering 110 such that they together comprise a single, unitary assembly. In the configuration shown in FIGS. 7 and 8, elastic polymer material covering 110 extends upwards from filter assemblies 150 and is affixed to the bottom and sides of eye-framing front rim 210 of goggles 200. Likewise, a portion of elastic polymer material covering 110 extends rearward from goggles 200 and includes a fastener 220, such as a buckle, configured for removable attachment to a mating fastener on a user's headpiece, such as a helmet (as shown in FIG. 9). In certain exemplary configurations, goggles 200 may comprise two adjacent lenses to allow folding of the goggles along a vertical centerline.

In accordance with still further aspects of an embodiment of the invention, the portion of elastic polymer material covering 110 that extends around the user's neck may be segmented so as to form a first strap 190(a) and a second strap 190(b), each having affixed thereto a portion of a connector to allow the wearer to temporarily and adjustably connect first strap 190(a) with second strap 190(b), and in turn control the extent to which the front of elastic polymer material covering 110, and thus interior sealing frame 180, is pulled towards and against the user's face. In certain exemplary configurations, such connectors on each of first strap 190(a) and second strap 190(b) may comprise mating sections of hook-and-loop fastening material.

In accordance with yet further aspects of an embodiment of the invention, mask 100 may optionally also include hydration and communication ports 192 and 194, and may also optionally include an outlet valve 196 to ease exhausting of exhaled breath from the wearer of mask 100.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

What is claimed is:

1. A protective system, comprising:
a flat-folding elastic polymer material covering having a lower portion sized to fit around a wearer's neck, an upwardly extending portion having a nose bridge portion positioned to overlap a bridge of the nose of the wearer, and a front spine portion extending downward from said nose bridge portion and terminating at a chin portion positioned to overlap a chin of the wearer;
a first flat filter assembly mounted on said elastic polymer material covering on a first side of said front spine and positioned to overlap a first cheek of the wearer;
a second flat filter assembly mounted on said elastic polymer material covering on a second side of said front spine opposite said first side and positioned to overlap a second cheek of the wearer; and
an interior sealing frame mounted to an interior of said elastic polymer material covering, said interior sealing frame forming a continuous wearer's face-engaging surface and defining a rear edge of an enclosed breathing cavity between the wearer's face and interior surfaces of said elastic polymer material covering and of said first and second flat filter assemblies.

2. The protective system of claim 1, said interior sealing frame further comprising an internal face engaging strip positioned on an interior perimeter of a mask mounting strip, wherein said continuous wearer's face-engaging surface is defined by an intersection of said internal face engaging strip and said mask mounting strip.

3. The protective system of claim 2, wherein said face engaging strip is positioned to sit flush against a bottom portion of a wearer's chin, extend rearward below the wearer's jawline, and extend upward from the wearer's rear jaw curving towards the bridge of the wearer's nose.

4. The protective system of claim 2, wherein an outer perimeter of said mask mounting strip is affixed to an interior of said flat-folding elastic fabric covering.

5. The protective system of claim 4, wherein said interior sealing frame is formed of flexible rubber.

6. The protective system of claim 4, wherein said interior sealing frame is positioned in said flat-folding elastic polymer material covering to position an interior surface of said first flat filter assembly and an interior surface of said second flat filter assembly away from a surface of the wearer's face.

7. The protective system of claim 1, wherein each of said first flat filter assembly and said second flat filter assembly is positioned within a filter frame having a rigidity that is greater than a rigidity of said flat-folding elastic polymer material covering, and wherein each of said first flat filter assembly and said second flat filter assembly further comprises a filter medium positioned inside of said filter frame.

8. The protective system of claim 7, wherein each said filter frame is fixedly and permanently affixed to said flat-folding elastic polymer material covering.

9. The protective system of claim 7, wherein each said filter frame is removably attached to a filter carrier, wherein each said filter carrier is permanently affixed to said flat-folding polymer material covering.

10. The protective system of claim 7, wherein each said filter medium further comprises an outer layer of mesh formed of semi-rigid plastic, a first layer of flexible mesh positioned below said outer layer, a plurality of layers of particulate filtration media positioned below said first layer of flexible mesh, at least one layer of activated carbon cloth positioned below said plurality of layers of particulate filtration media, at least one bottom layer of particulate filtration media positioned below said layer of activated carbon cloth, and a second layer of flexible mesh positioned below said at least one bottom layer of particular filtration media.

11. The protective system of claim 10, wherein each of said plurality of layers of particulate filtration media and said at least one bottom layer of particulate filtration media further comprises electret media.

12. The protective system of claim 1, further comprising goggles having an eye framing front rim defining a nose bridge portion, wherein said nose bridge portion further comprises angled sidewalls configured to match a contour of an upper, outer edge of said front spine portion of said flat-folding elastic fabric covering.

13. The protective system of claim 12, said googles further comprising a rear face-engaging continuous rim configured to form a continuous seal against a wearer's face, wherein said rear face-engaging continuous rim extends above said eye-framing front rim.

14. The protective system of claim 1, further comprising goggles having an eye framing front rim, wherein said front rim is affixed to said elastic polymer material covering.

15. The protective system of claim 14, said elastic polymer material covering have upper connecting straps each having a first connector configured for removable attachment to a mating connector on a helmet, and wherein said lower portion of said elastic polymer material covering further comprises rearwardly extending lower straps each having mating connectors on each said lower strap.
